(19) United States
(12) Patent Application Publication
(10) Pub. No.: US 2001/0025885 A1
(43) Pub. Date: Oct. 4, 2001

(54) Magnetic card reader and method of demodulating magnetic data

(76) Inventors: Yukio Kuroiwa, Nagano (JP); Eiji Imai, Nagano (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/765,378

(22) Filed: Jan. 22, 2001

(30) Foreign Application Priority Data
Jan. 21, 2000 (JP) P.2000-12872

(51) Int. Cl. G06K 7/08

(52) U.S. Cl. 235/449

(57) ABSTRACT

A magnetic card reader 1 is adapted to make a magnetic card and magnetic heads 4 to relatively move with respect to each other and also adapted to demodulate data, which is recorded on the magnetic card and obtained by the magnetic heads 4. This magnetic card reader 1 comprises two magnetic heads 4a and 4b arranged in a direction, in which each of the magnetic heads 4a and 4b relatively moves with respect to the magnetic card, and adapted to take in the same data from the magnetic card and to obtain two demodulated data, an error detecting portion 5 for detecting an error in at least one of the two demodulated data, and an error correcting portion 6 for correcting the error, which is detected by the error detecting portion 5, by using the other demodulated data. When a read error is detected, the error correcting portion 6 corrects an erroneous part of one of the two demodulated data into normal data by using the other demodulated data.

### BACKGROUND OF INVENTION

1. Field of Invention

The present invention generally relates to an apparatus for reading digital information records and to a method of reproducing digital data. More particularly, the present invention relates to a magnetic card reader and to a method of demodulating magnetic data.

2. Related Art

Hitherto, there have been known card readers for reading magnetic data on a magnetic card, which are as illustrated in, for example, FIGS. 7 to 9. A magnetic card 101 has a sliding slot 103 into which a magnetic card 102 is inserted and in which the magnetic card 102 slides, a magnetic head 104 for reading magnetic data, and a circuit board 105 for processing a signal representing the read data. A magnetic stripe 106, on which magnetic data is recorded, is provided on a surface of the magnetic card 102. The magnetic head 104 is brought into contact with the magnetic stripe 106 by inserting the magnetic card 102 into the sliding slot 103. When the magnetic data is read, the magnetic card 102 is inserted into the sliding slot 103 and moved so that the card 102 slides in a direction of an arrow A shown in this figure. In the case that the magnetic card reader 101 is of the manual type, this operation is manually performed. On the other hand, in the case that the magnetic card reader 101 is of what is called the motor carrier type, this operation is performed by using a conveying motor. Thus, the relative positional relation between the magnetic stripe 106 and the magnetic head 104 is changed, so that the magnetic head 104 serially reads the magnetic data recorded on the magnetic stripe 106. The magnetic data read by the magnetic head 104 is inputted to the circuit board 105 as an analog signal. The inputted data is then waveform-shaped and demodulated into digital data. The demodulated data is stored in the memory 109 and transmitted by a CPU 108 to a host computer (not shown) through an IC interface 110.

The conventional magnetic card reader 101, however, has a drawback in that when the speed of the magnetic card 102 extremely decreases or when the magnetic card 102 stops, the magnetic data cannot be read and thus a read error occurs. In the case that the magnetic card reader 101 is of the manual type, the magnetic card is manually operated, so that it is difficult to cause the magnetic card 102 to operate at a constant speed. Thus, the speed of the magnetic card 102 decreases. Consequently, the probability of an occurrence of a read error is high. Especially, a person, who is unaccustomed to operate a magnetic card, is apt to pass the card from one hand to the other hand during he inserts the card 102 into the reader 101. At that time, the card 102 completely stops therein. Thus, a read error occurs. Further, in the case that the magnetic card reader 101 is of the type in which a magnetic card is conveyed by using a motor, a read error may occur in a part of the magnetic data owing to, for example, a collision of conveying rollers. In the case of the conventional magnetic card reader 101, even when such a read error occurs in a part of the magnetic data, there is the necessity for reading the magnetic card again.

### SUMMARY OF INVENTION

Accordingly, an object of the invention is to provide a magnetic card reader that does not need to read the magnetic card 102 again even when a read error occurs and that can correct an erroneous portion, and to provide a method of demodulating magnetic data.

To achieve such an object, according to an aspect of the invention, there is provided a magnetic card reader (hereunder referred to as a first magnetic card reader) adapted to make a magnetic card and at least one magnetic head to relatively move with respect to each other and also adapted to demodulate data, which is recorded on the magnetic card and obtained by the magnetic head. This magnetic card reader comprises two magnetic heads arranged in a direction, in which each of the magnetic heads relatively moves with respect to the magnetic card, and adapted to take the same data from the magnetic card and to obtain two demodulated data, an error detecting portion for detecting an error in at least one of the two demodulated data, and an error correcting portion for correcting the error, which is detected by the error detecting portion, by using the other demodulated data.

In this case, the two magnetic heads are series-arranged in a direction, in which the magnetic heads read the magnetic card, and brought into contact with a magnetic stripe annexed onto a surface of the magnetic card by inserting the magnetic card into the magnetic card reader. The same magnetic data provided on the same magnetic stripe is read by each of the two magnetic heads as an analog signal. Each of the analog signals is waveform-shaped and demodulated into demodulation data that is an aggregate of binary data represented by bits each having a binary value of “1” or “0”. Thus, two demodulated data are obtained. Incidentally, when a read error occurs during the magnetic card is read, an error in demodulation (hereunder referred to as a bit error), by which the read analog signal is not demodulated into original and correct bits, is caused. Thus, the error detecting portion detects bit errors in the two demodulation data. When a bit error is detected, the error correcting portion corrects an erroneous part of one of the two demodulated data into normal data by using the other demodulated data. The two magnetic head demodulate data respectively corresponding to different parts of the magnetic stripe. Thus, it is considered that the latter demodulated data is normal. Consequently, even when a read error occurs, the erroneous part can be corrected without reading the magnetic card again.

According to an embodiment (hereunder referred to as a second magnetic card reader) of the first magnetic card reader of the invention, the error correcting portion is adapted to correct errors, which occur in the demodulated data, character by character.

Incidentally, a set of a predetermined number of bits of the modulated data constitutes data (hereunder referred to as character data) representing each character. The entire modulated data consists of a set of such character data. The error detecting portion checks the two modulated data by judging whether or not an error occurs in each of the character data thereof. When an error is detected, the error correcting portion corrects the error in the two demodulated data by replacing character data included in the modulated data, in which the error is detected, with normal character data, which is included in the other modulated data and corresponds to the former character data.

Further, according to an embodiment (hereunder referred to as a third magnetic card reader) of the second magnetic card reader of the invention, the error detecting portion may be adapted to detect whether or not the parity of the modulated data corresponding to each character is correct. The detection of an error is performed on the data corresponding to each character by utilizing a parity check that has been hitherto utilized for detecting a bit error. Moreover, the error correcting portion can correct erroneous one of the two demodulated data into normally modulated data by replacing character data included in the modulated data, in which the error is detected, with normal character data, which is included in the other modulated data and corresponds to the former character data.

According to another aspect of the invention, there is provided a magnetic data demodulating method (hereunder referred to a first magnetic data demodulating method) of making a magnetic card and at least one magnetic head to relatively move with respect to each other and demodulating data, which is recorded on the magnetic card and obtained by the magnetic head. This method comprises the steps of providing two magnetic heads in such a manner as to be arranged in a direction, in which each of the magnetic heads relatively moves with respect to the magnetic card, and taking the same data from the magnetic card to thereby generate two demodulated data, and detecting an error in at least one of the two demodulated data, and correcting the detected error by using the other demodulated data.

In this case, the same magnetic data provided on the same magnetic stripe is read by each of the two magnetic heads as an analog signal. Each of the analog signals is waveform-shaped and demodulated into demodulation data that is an aggregate of binary data represented by bits each having a binary value of “1” or “0”. Thus, two demodulated data are obtained. Incidentally, when a read error occurs during the magnetic card is read, a bit error is caused in the demodulated data. Thus, the error detecting portion detects bit errors in the two demodulation data. However, the two magnetic head demodulate data respectively corresponding to different parts of the magnetic stripe. Therefore, it is considered that an error occurs in a part of one of the two demodulated data, while no error should occur in a corresponding part of the other demodulated data. Thus, the detection of a bit error is performed on each character data of the two demodulated data. Consequently, even when a read error occurs, the erroneous part can be corrected into normal demodulated data by replacing character data included in the modulated data, in which an error is detected, with normal character data, which is included in the other modulated data and corresponds to the former character data.

Furthermore, according to an embodiment (hereunder referred to as a second magnetic data demodulating method) of this magnetic data demodulating method, the modulated data, which is an aggregate of the binary data, may be corrected character by character after the two modulated data are stored in a memory as binary data represented by bits each having a binary value of “1” or “0”. In this case, the two modulated data, on which error detection and error correction are performed, are stored in the memory. Thus, the magnetic data can be demodulated without restricting the error detection timing and the error correction timing.

### BRIEF DESCRIPTION OF DRAWINGS

FIG. 1 is a block diagram illustrating an example of a magnetic card reader and a magnetic data demodulating method of the invention;

FIG. 2 is a schematic side view of the magnetic card reader of the invention;

FIG. 3 is a conceptual diagram illustrating a state in which magnetic data is read from a magnetic card;

FIG. 4(A) and (B) are schematic diagrams illustrating the waveforms of analog signals respectively read from two magnetic heads;

FIG. 4(A) illustrates the waveform of an analog signal read from one of the magnetic heads,

FIG. 4(B) illustrates the waveform of another analog signal read from the other magnetic head.

FIG. 5(D) is a schematic diagram illustrating an example of an error correction,

FIG. 5(A) illustrates data read from one of the magnetic heads and demodulated;

FIG. 5(B) illustrates data read from the other magnetic head and demodulated;

FIG. 5(C) illustrates corrected and demodulated data;

FIG. 6 is a flowchart illustrating an example of a magnetic data demodulating method of the invention;

FIG. 7 is a block diagram illustrating a conventional magnetic card reader and a conventional magnetic data demodulating method;

FIG. 8 is a schematic side view of the conventional magnetic card reader; and

FIG. 9 is a conceptual diagram illustrating a state in which magnetic data is read from a magnetic card in the conventional magnetic card reader.

### DETAILED DESCRIPTION OF PREFERRED EMBODIMENTS

Hereinafter, an apparatus and method of the invention are described in detail, based on embodiments thereof illustrated in the accompanying drawings. FIGS. 1 to 6 illustrate a magnetic card reader 1 and a magnetic data reproducing method, which embody the invention.

A magnetic card reader 1 of the invention is adapted to make a magnetic card 2 and magnetic heads 4 to relatively move with respect to each other and also adapted to demodulate data, which is recorded on the magnetic card 2 and obtained by the magnetic heads 4. This magnetic card reader 1 comprises two magnetic heads arranged to thereby take in the same data from the magnetic card 2 and obtain two demodulated data. The magnetic card reader 1 further comprises an error detecting portion 5 for detecting an error in one of the two demodulated data, and an error correcting portion 6 for correcting the erroneous part, which is detected by the error detecting portion 5, of the demodulated data by using the other demodulated data.

As shown in FIG. 2, the magnetic card reader 1 has a sliding slot 3, in which the magnetic card 2 is inserted and slid, and magnetic heads 4a and 4b for reading magnetic data recorded on the magnetic card 2, and a circuit board 7 for processing the read magnetic data. The magnetic heads 4a and 4b are series-arranged in a direction, in which the magnetic card 2 is read, in such a way as to read the same data. Further, as shown in FIG. 3, a magnetic stripe 8, on which magnetic data is recorded, is provided on the surface of the magnetic card 2. The magnetic heads 4a and 4b are brought into contact with the magnetic stripe 8 by inserting the magnetic card 2 into the sliding slot 3. Thus, the same magnetic data provided on the same magnetic stripe 8 are read by the two magnetic heads 4a and 4b to thereby obtain the two demodulated data. Incidentally, the installation interval between the two magnetic heads 4a and 4b is not limited to a specific value. As long as a value of the installation interval therebetween is within a range that allows the magnetic heads 4a and 4b to take in the magnetic data, such a value may be employed as the installation interval therebetween.

Meanwhile, when the magnetic data is read, the magnetic card 2 is inserted into the sliding slot 3 and moved so that the card 2 slides in a direction of an arrow A shown in FIG. 2. In the case that the magnetic card reader 1 is of the manual type, this operation is manually performed. On the other hand, in the case that the magnetic card reader 1 is of what is called the motor carrier type, this operation is performed by using a conveying motor. Thus, the relative positional relation between the magnetic stripe 8 and each of the magnetic heads 4a and 4b is changed, so that the magnetic heads 4a and 4b serially read the magnetic data recorded on the magnetic stripe 8. Incidentally, although FIG. 2 illustrates the magnetic card reader 1 of the manual type, needless to say, a magnetic card reader of the motor carrier type may be employed.

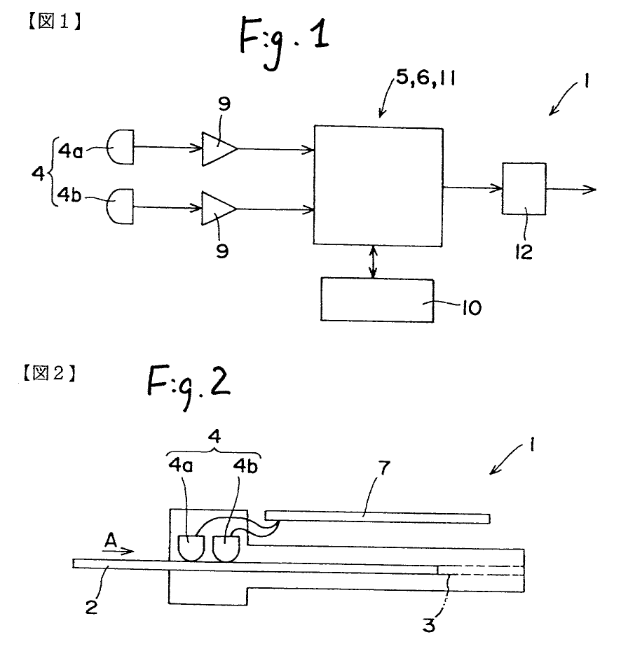

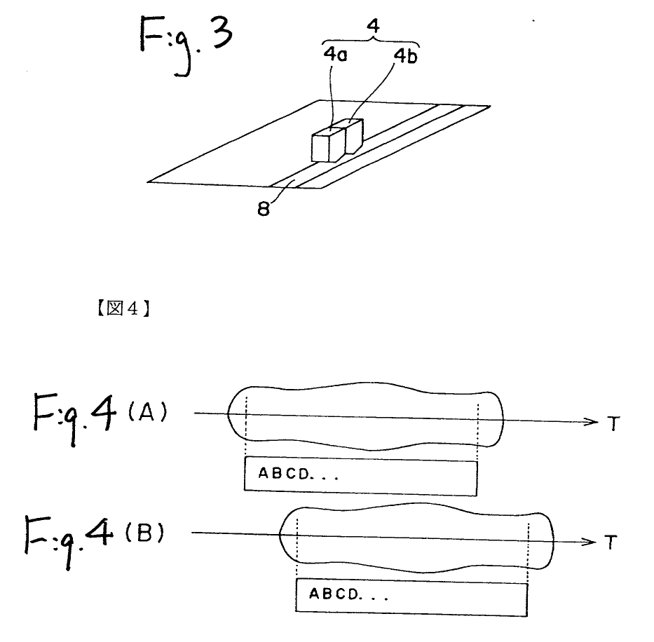

The magnetic data read by the magnetic heads 4a and 4b are inputted to the circuit board 7 as an analog signal. In FIG. 4, (A) illustrates the analog waveform of the signal representing the magnetic data read by the magnetic head 4a, while (B) illustrates the analog waveform of the signal representing the magnetic data read by the magnetic head 4b. Incidentally, the axis T of abscissa represents time. Each of the magnetic heads 4a and 4b reads all data from the same magnetic stripe 8. However, the difference in the reading position between the heads 4a and 4b causes a time lag between the analog signals respectively corresponding to the heads 4a and 4b.

The two analog signals read by the magnetic heads 4a and 4b are respectively waveform-shaped by the demodulating circuits 9, 9 into two digital signals. These two digital signals are demodulated independently of each other into two demodulated data that are aggregates of binary data and stored in the memory 10.

Meanwhile, in the case that a read error occurs owing to an abrupt change in the speed of the magnetic card 2 during the magnetic data is read, the magnetic data is not demodulated into original correct bits. Thus, a bit error occurs. The error detecting portion 5 is configured in such a manner as to detect bit errors in the two demodulated data stored in the memory 10. Incidentally, the error detecting portion 5 may be constituted by firmware for detecting a bit error in the demodulated data by the CPU 11. Alternatively, an error detecting circuit dedicated to the error detection may be provided in the card reader.

Meanwhile, a set of a predetermined number of bits of the modulated data constitutes character data representing each character. The entire modulated data consists of a set of such character data. The error detecting portion performs an error check on each of such character data and an error check on the entire demodulated data correspondingly to each of the demodulated data.

For example, an even parity check, which has been hitherto utilized for detecting a bit error, can be employed as a method for performing a parity check. In original data, a parity bit is added to each character data. Moreover, a parity bit is added to the end of the entire original data. The parity bit is added thereto so that the total number of binary 1's included in the bit set within a check range is even. The even parity check on each character data enables the error detecting portion 5 to detect whether or not the character data is correct. Furthermore, the even parity check on the entire modulated data enables the error detecting portion 5 to detect whether or not the demodulated data read by this portion is correct. Incidentally, the method for error check is not limited to the even parity check. An odd parity check may be employed as the method for error check.

The error correcting portion 6 is configured so that when an error is detected, the portion 6 corrects the error in the two demodulated data by replacing character data included in the modulated data, in which the error is detected, with normal character data, which is included in the other modulated data and corresponds to the former character data. Incidentally, the error correcting portion 6 may be constituted by firmware for performing such an error correction by the CPU 11. Alternatively, an error correcting circuit dedicated to the error detection may be provided in the card reader.

As illustrated in FIG. 4, there is caused a time lag between the analog signals representing the magnetic data obtained from the heads 4a and 4b, respectively. Consequently, there is caused a time lag between the analog signals representing the data demodulated from the magnetic data.

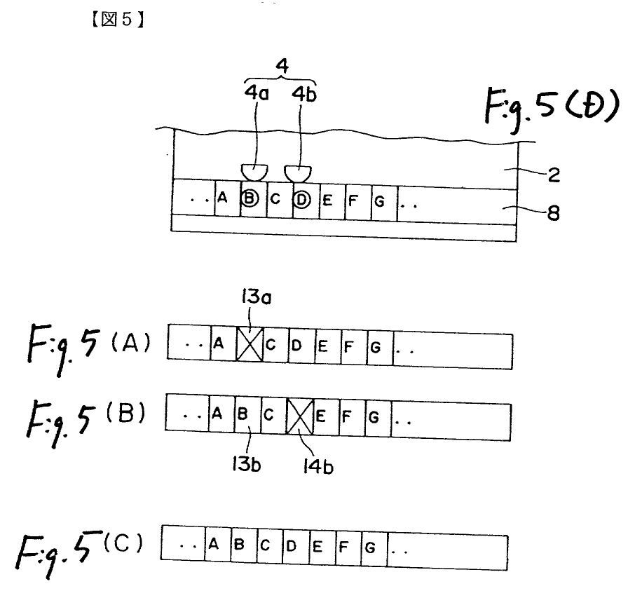

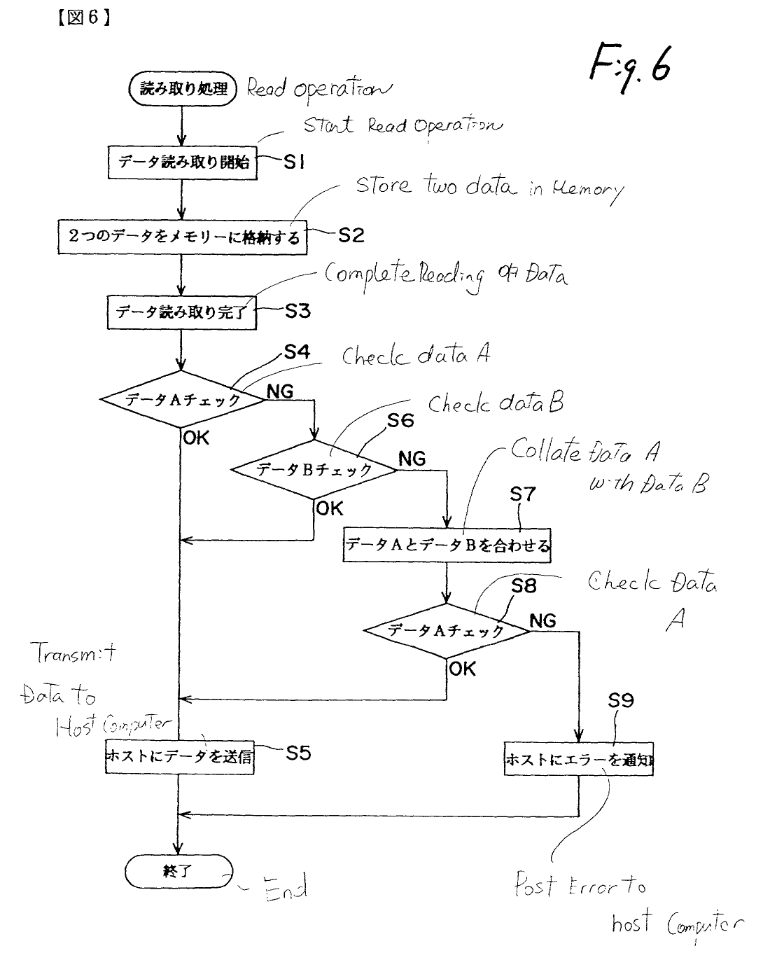

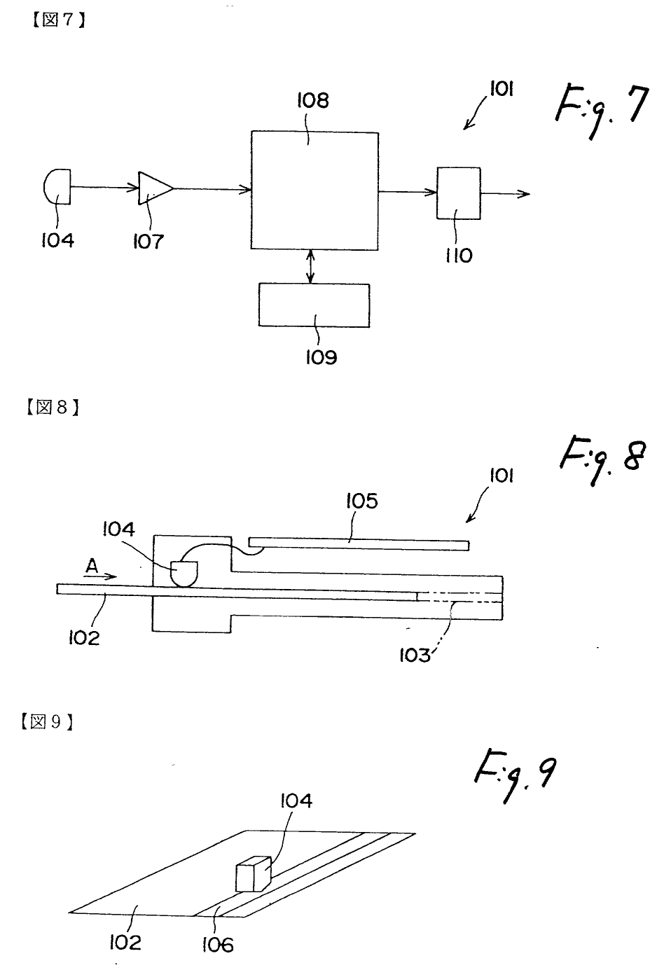

FIG. 5 illustrates a state in which a read error occurs at a certain point in time, for instance, a state in which the magnetic card 2 temporarily stops when an operator passes the card 2 from one hand to the other hand in the case of using the card reader of the manual type. At that time, in the demodulated data (hereunder referred to as data A) read by the magnetic head 4a and shown in (A) of FIG. 5, a bit error occurs in character data 13a, which has been read by the magnetic head 4a when the error occurs. On the other hand, in the demodulated data (hereunder referred to as data B) read by the magnetic head 4b and shown in (B) of FIG. 5, a bit error occurs in character data 14b, which has been read by the magnetic head 4b when the error occurs. Thus, although the data A and the data B are read from the same magnetic stripe 8 and originally the same, a read error simultaneously caused affects different parts respectively corresponding to the two demodulated data. Incidentally, the character data 13b, which is included in the data B, corresponding to the character data 13a, in which a bit error occurs, of the data A is read at a moment different from the moment, at which the bit error occurs. Therefore, there is a strong likelihood that the character data 13b is normal. Thus, the error correcting portion 6 replaces the character data 13a, in which an error is detected during error check is performed by the error detecting portion 5, of the data A with the normal character data 13b included in the data B. Consequently, the error correcting portion 6 generates the normal modulated data shown in (C) of FIG. 5. At that time, an error check is performed on the data B. Thus, it is assumed that the normality of the character data 13b is verified.

With such configuration, when a read error occurs, the erroneous part of one of the two demodulated data can be corrected into normal data by using the other demodulated data.

Further, the normal demodulated data is transmitted by the CPU 11 to a host computer (not shown) through an IC interface 12.

Next, an example of an operation of demodulating the magnetic data by using the aforementioned magnetic card reader 1 is described hereinbelow with reference to a flowchart of FIG. 6.

Reading of the magnetic data is started at step 1 by inserting the magnetic card 2 into the sliding slot 3 and moving the card 2 in such a way as to slide in a direction of an arrow A shown in FIG. 2. In the case that the magnetic card reader 1 is of the manual type, this operation is manually performed. Thus, the relative positional relation between the magnetic stripe 8 and each of the magnetic heads 4a and 4b is changed, so that the magnetic heads 4a and 4b serially read the magnetic data recorded on the magnetic stripe 8. Then, the magnetic data read by the magnetic heads 4a and 4b are inputted to the circuit board 7 at step 1 as an analog signal.

The magnetic data inputted to the circuit board 7 are waveform-shaped into the two demodulated data by a corresponding one of the demodulating circuits 9, 9. Then, the two demodulated data are stored in the memory 10 at step 2. After all the magnetic data are read by the magnetic heads 4a and 4b to thereby obtain two demodulated data, the reading of the magnetic data is finished at step 3.

The error detecting portion 5 performs an even parity check on each of the character data of the data A, which is the demodulated data read by the magnetic head 4a, and on the entire demodulated data at step 4. When no error is detected in the data A, the CPU 11 decides that the data A is normal data. Then, the CPU 11 sends the data A to the host computer at step 5.

Conversely, when an error is detected in the data A, the error detecting portion 5 performs an even parity check on each of the character data of the data B, which is the demodulated data read by the magnetic head 4b, and on the entire demodulated data at step 6. When no error is detected in the data B, the CPU 11 decides that the data B is normal data. Then, the CPU 11 transmits the data A to the host computer at step 5.

In the case that errors are detected in both the data A and the data B, the error correcting portion 6 performs data correction at step 7. The character data, which is included in the data B, corresponding to the character data, in which the error occurs, of the data A is read at a moment different from the moment, at which the error occurs. Therefore, there is a strong likelihood that the character data of the data B is normal. Consequently, the error correcting portion 6 corrects the data A at step 7 by replacing the character data, in which the error is detected, of the data A with the character data, which is included in the data B and corresponds to this character data of the data A.

Subsequently, the error detecting portion 5 performs an even parity check on each of the character data of the corrected data A and an even parity check on the entire demodulated data so as to enhance the reliability of correction processing performed in the error correcting portion 6 at step 8.

When no error is detected in the corrected data A, the CPU 11 decides that the corrected data A is normal data. Then, the CPU 11 transmits the data A to the host computer at step 5. Conversely, when an error is detected in the corrected data A, the CPU 11 decides that the error cannot be corrected. Then, the CPU 11 posts the error to the host computer at step 9.

As described above, according to the magnetic card reader 1 and the magnetic data demodulating method of the invention, the magnetic card reader comprises two magnetic heads adapted to obtain two demodulated data. Moreover, an erroneous part of one of the demodulated data by using the other demodulated data. Thus, even when a read error occurs, the erroneous part can be corrected without needing to read the magnetic card again. Incidentally, the accuracy can be enhanced still more by adapting the magnetic card reader in such a way as to detect and correct erroneous parts of both the two demodulated data and to further detect whether or not the detected erroneous parts are matched with each other. Furthermore, the erroneous parts can be corrected on the basis of the two demodulated data. Thus, the reading accuracy can be enhanced, as compared with the case of correcting the error, based on one piece of correction data.

Further, according to the magnetic card reader and the magnetic data demodulating method of the invention, the error check and the error correction are performed on the demodulated data, that is, binary data. Thus, the demodulation of the magnetic data can be simply performed at a high speed, as compared with an operation of generating correction data by analyzing the analog data before waveform-shaped.

Furthermore, according to the magnetic data demodulating method of the invention, the waveform-shaped demodulated data is stored in the memory 10. Thus, the memory capacity can be considerably saved, as compared with the case of storing an enormous amount of data in the memory 10 by sampling the analog data, which is not waveform-shaped, as correction data when an error occurs.

Incidentally, although the aforementioned embodiment is a preferable embodiment of the invention, the invention is not limited thereto. Various modifications may be made in the invention without departing from the gist of the invention.

For example, more than two magnetic heads 4 may be provided in the magnetic card reader. In view of a restriction in the design or production cost of a magnetic card reader, there is a limit to the number of magnetic heads 4. However, the error-correction accuracy of the card reader can be enhanced with increase in the amount of demodulated data to be read.

Further, the detection method of detecting digital signals in the two demodulating circuits 9, 9 is not limited to a specific method. The two demodulating circuits may employ different detection methods, respectively. For instance, one of the two demodulating circuits may employ a peak detection method, while the other demodulating circuit may employ a level detection method.

Furthermore, the magnetic card reader may be configured in such a manner as to be able to operate by using only one of the magnetic heads even when the other magnetic head is out of order. Consequently, the failure rate of the magnetic card reader can be reduced.

Further, this embodiment employs the magnetic card reader adapted to perform an error check on both the character data and the entire demodulated data so as to achieve highly reliable error detection. However, a magnetic card reader adapted to perform the error check only on the character data. Alternatively, the magnetic card reader may be adapted so that the error correcting portion 6 immediately performs data correction by omitting error check to be performed on the data B (step 6) in the case that an error is detected in the data A. Alternatively, the magnetic card reader may be adapted so that error check to be performed on the data A (step 9) is omitted after the error correction.

Furthermore, the processing to be performed in each of the error detecting portion 5 and the error correcting portion 6 is not necessarily performed upon completion of reading data at step 3 illustrated in the flowchart of FIG. 6. The two data, on which processing is performed by the error detecting portion 5 and the error correcting portion 6, are stored in the memory 10, so that the demodulation of magnetic data can be performed without restricting the processing timing.

As is apparent from the foregoing description, according to the first magnetic card reader, a magnetic card and at least one magnetic head are made to relatively move with respect to each other. The first magnetic card reader is adapted to demodulate data, which is recorded on the magnetic card and obtained by the magnetic head. This magnetic card reader comprises two magnetic heads arranged in a direction, in which each of the magnetic heads relatively moves with respect to the magnetic card, and adapted to take in the same data from the magnetic card and to obtain two demodulated data. Moreover, this magnetic card reader further comprises an error detecting portion for detecting an error in at least one of the two demodulated data, and an error correcting portion for correcting the error, which is detected by the error detecting portion, by using the other demodulated data. Thus, even when a read error occurs, the erroneous part can be corrected without reading the magnetic card again. Moreover, because the erroneous part can be corrected on the basis of the two demodulated data, the reading accuracy is enhanced, as compared with the case of correcting an error based on one correction data. Furthermore, the error check and the error correction are performed on the demodulated data, that is, binary data. Thus, the demodulation of the magnetic data can be simply performed at a high speed, as compared with an operation of generating correction data by analyzing the analog data before waveform-shaped. Besides, because the first magnetic card reader is of the dual head type that has two magnetic heads, this card reader can operate by using only one of the two magnetic heads even when the other magnetic head is out of order. Consequently, the failure rate of the magnetic card reader can be reduced.

Furthermore, according to the second magnetic card reader, the error correcting portion corrects errors by checking the demodulated data character by character. Thus, the second magnetic card reader can achieve an error correction of each set of a predetermined number bits at a time. Consequently, the simplification and speedup of the correction can be achieved.

Further, similarly as the third magnetic card reader, the error detecting portion may be adapted to detect whether or not the parity of the modulated data corresponding to each character is correct. The error detection and the error correction can be easily and reliably achieved by utilizing a parity check that has been hitherto utilized for detecting a bit error.

Moreover, according to the first magnetic data demodulating method, a magnetic card and at least one magnetic head are made to relatively move with respect to each other and demodulating data, which is recorded on the magnetic card and obtained by the magnetic head. This method comprises the steps of providing two magnetic heads in such a manner as to be arranged in a direction, in which each of the magnetic heads relatively moves with respect to the magnetic card, and taking in the same data from the magnetic card to thereby generate two demodulated data, and detecting an error in at least one of the two demodulated data, and correcting the detected error by using the other demodulated data. Thus, even when a read error occurs, the erroneous part can be corrected without needing to read the magnetic card again. Moreover, because the erroneous part can be corrected on the basis of the two demodulated data, the reading accuracy is enhanced, as compared with the case of correcting an error based on one correction data. Furthermore, the error check and the error correction are performed on the demodulated data, that is, binary data. Thus, the demodulation of the magnetic data can be simply performed at a high speed, as compared with an operation of generating correction data by analyzing the analog data before waveform-shaped.

Furthermore, similarly as the second magnetic demodulating method, the modulated data, which is an aggregate of the binary data, may be corrected character by character after the two modulated data are stored in a memory as binary data represented by bits each having a binary value of “1” or “0”. In this case, the two modulated data, on which the error detection and the error correction are performed, are stored in the memory. Thus, the magnetic data can be demodulated without restricting the error detection timing and the error correction timing. Further, the flexibility of design can be enhanced. Moreover, according to this magnetic data demodulating method of the invention, the waveform-shaped demodulated data is stored in the memory. Thus, the memory capacity can be considerably saved, as compared with the case of storing an enormous amount of data in a memory by sampling the analog data, which is not waveform-shaped, as correction data when an error occurs.

What is claimed is:

1. A magnetic card reader adapted to make a magnetic card and at least one magnetic head to relatively move with respect to each other and also adapted to demodulate data, which is recorded on said magnetic card and obtained by said magnetic head, said magnetic card reader comprising:
two magnetic heads arranged in a direction, in which each of said magnetic heads relatively moves with respect to said magnetic card, and adapted to take same data from said magnetic card and to obtain two demodulated data;
an error detecting portion for detecting an error in at least one of the two demodulated data; and
an error correcting portion for correcting the error, which is detected by said error detecting portion, by using the other demodulated data.

2. The magnetic card reader according to claim 1, wherein said error correcting portion is adapted to correct errors, which occur in the demodulated data, character by character.

3. The magnetic card reader according to claim 2, wherein said error detecting portion is adapted to detect whether or not a parity of the modulated data corresponding to each character is correct.

4. A magnetic data demodulating method of making a magnetic card and at least one magnetic head to relatively move with respect to each other and demodulating data, which is recorded on said magnetic card and obtained by said magnetic head, said method comprising the steps of:
providing two magnetic heads in such a manner as to be arranged in a direction, in which each of said magnetic heads relatively moves with respect to said magnetic card, and taking same data from said magnetic card to thereby generate two demodulated data;
detecting an error in at least one of said two demodulated data; and
correcting the detected error by using the other demodulated data.

5. The magnetic data demodulating method according to claim 4, wherein after the two modulated data are stored in a memory as binary data represented by bits each having a binary value of “1” or “1” the modulated data, which is an aggregate of the binary data, is corrected character by character.
